(19) United States
(12) Patent Application Publication
(10) Pub. No.: US 2024/0383301 A1
(43) Pub. Date: Nov. 21, 2024

(54) SINGLE AXLE HEAVE CONTROL SYSTEM

(71) Applicant: DRiV Automotive Inc., Northville, MI (US)

(72) Inventors: Miguel DHAENS, Lommel (BE); Monzer AL SAKKA, Sint-Truiden (BE)

(73) Assignee: DRiV Automotive Inc., Northville, MI (US)

(21) Appl. No.: 18/197,126

(22) Filed: May 15, 2023

(51) Int. Cl. B60G 17/08; B60G 9/02; B60G 13/08; B60G 17/015; B60G 17/016; F15B 21/00

(52) U.S. Cl. CPC B60G 17/08; B60G 9/02; B60G 13/08; B60G 17/0152; B60G 17/0164; F15B 21/005; B60G 2202/24; B60G 2204/62; B60G 2204/82; B60G 2204/8304; B60G 2206/41; B60G 2500/104; B60G 2600/182; B60G 2800/014; B60G 2800/164; B60G 2800/9123

(57) ABSTRACT

A single axle suspension system that includes right and left dampers, first and second hydraulic circuits, and a pressurizing mechanism that is connected in fluid communication with at least one of the hydraulic circuits. The pressurizing mechanism is configured to provide active heave control by adding and removing hydraulic fluid to and from at least one of the hydraulic circuits to increase and decrease pressure inside at least one of the hydraulic circuits independent of damper movements. This in turn causes a simultaneous increase in the fluid pressure inside either the first working chambers of the right and left dampers or the second working chambers of the right and left dampers to provide pitch stiffness that counters fore and aft heave of the vehicle. The pressurizing mechanism is either a bi-directional pump or a ball/screw mechanism that actuates a variable volume chamber.

### FIELD

The present disclosure relates generally to suspension systems for motor vehicles and more particularly to single axle suspension systems that replace or augment mechanical stabilizer bars.

### BACKGROUND

The statements in this section merely provide background information related to the present disclosure and may not constitute prior art.

Suspension systems improve the ride of a vehicle by absorbing bumps and vibrations that would otherwise unsettle the vehicle body. Suspension systems also improve safety and control by improving contact between the ground and the tires of the vehicle. One drawback of suspension systems is that basic spring/damper arrangements will allow the vehicle to pitch/lean during heavy braking and/or acceleration. The longitudinal acceleration the vehicle experiences in turns causes a roll moment where the vehicle will lean/squat fore or aft. The roll moment decreases grip and performance and also can be uncomfortable to the driver and passengers.

Many vehicles are equipped with stabilizer bars, which are mechanical systems that help counteract the roll moments experienced during operation of the vehicle. Stabilizer bars are typically mechanical linkages that extend laterally across the width of the vehicle between the right and left dampers. When one of the dampers extends, the stabilizer bar applies a force to the opposite damper that counteracts the roll moment of the vehicle and helps to correct the roll angle to provide flatter cornering. However, there are several drawbacks associated with these mechanical systems. First, there are often packaging constraints associated with mechanical systems because a stabilizer bar requires a relatively straight, unobstructed path across the vehicle between the right and left dampers. Second, stabilizer bars/anti-roll bars are reactive and therefore only work when the suspension starts moving (i.e., leaning). Most mechanical stabilizer bars are also less effective at controlling fore and aft pitching motions of the suspension system (i.e., heave). For example, vehicles typically pitch forward (i.e., front axle squat) under hard braking and may pitch backwards (i.e., rear axle squat) under hard acceleration or when heavily loaded/towing. This problem is more problematic and needs correction in high performance vehicles due to the level of their performance and in electric or hybrid vehicles due to added battery weight.

### SUMMARY

This section provides a general summary of the disclosure and is not a comprehensive disclosure of its full scope or all of its features.

In accordance with one aspect of the subject disclosure, a single axle suspension system is provided. The single axle suspension system includes right and left dampers. Each of the right and left dampers includes a damper housing, a piston rod, and a piston that is mounted on the piston rod. The piston is arranged in sliding engagement inside the damper housing such that the piston divides the damper housing into first and second working chambers. The first working chamber of the right damper is connected in fluid communication with the first working chamber of the left damper by a first hydraulic circuit. The second working chamber of the right damper is connected in fluid communication with the second working chamber of the left damper by a second hydraulic circuit. There is no cross-over between the first and second hydraulic circuits and the single axle suspension system further includes a pressurizing mechanism that is connected in fluid communication with the second hydraulic circuit. The pressurizing mechanism is configured to add and remove hydraulic fluid to and from the second hydraulic circuit to increase and decrease pressure inside the second hydraulic circuit independent of damper movements. The pressurizing mechanism is connected to a controller that is configured to initiate an active heave control operation by actuating the pressurizing mechanism.

In accordance with another aspect of the present disclosure, the single axle suspension system includes right and left dampers. Each of the right and left dampers includes a damper housing, a piston rod, and a piston that is mounted on the piston rod. The piston is arranged in sliding engagement inside the damper housing such that the piston divides the damper housing into first and second working chambers. The single axle suspension system includes a first hydraulic line that extends between and fluidly connects the first working chamber of the right damper and the first working chamber of the left damper and a second hydraulic line that extends between and fluidly connects the second working chamber of the right damper and the second working chamber of the left damper. There is no cross-over between the first and second hydraulic lines and the single axle suspension system further includes a pressurizing mechanism that is connected in fluid communication with the second hydraulic line. The pressurizing mechanism is a ball/screw mechanism with a variable volume chamber and is configured to add and remove hydraulic fluid to and from the second hydraulic line to increase and decrease pressure inside the second hydraulic line independent of damper movements. The pressurizing mechanism is connected to a controller that is configured to initiate an active heave control operation by actuating the pressurizing mechanism.

In accordance with another aspect of the present disclosure, the single axle suspension system includes right and left dampers. Each of the right and left dampers includes a damper housing, a piston rod, and a piston that is mounted on the piston rod. The piston is arranged in sliding engagement inside the damper housing such that the piston divides the damper housing into first and second working chambers. The first working chamber of the right damper is connected in fluid communication with the first working chamber of the left damper by a first hydraulic circuit. The second working chamber of the right damper is connected in fluid communication with the second working chamber of the left damper by a second hydraulic circuit. There is no cross-over between the first and second hydraulic circuits and the single axle suspension system further includes a pressurizing mechanism that is connected in fluid communication with the second hydraulic circuit. The pressurizing mechanism is a bi-directional pump that is configured to add and remove hydraulic fluid to and from the second hydraulic circuit to increase and decrease pressure inside the second hydraulic circuit independent of damper movements. The bi-directional pump is connected to a controller that is configured to initiate an active heave control operation by actuating the pressurizing mechanism. The bi-directional pump has a first bi-directional conduit that is arranged in fluid communication with the first hydraulic circuit and a second bi-directional conduit that is arranged in fluid communication with the second hydraulic circuit.

The controller actuates the bi-directional pump in a first working mode where the bi-directional pump increases fluid pressure in the first hydraulic circuit and therefore the first working chambers of the right and left dampers and decreases fluid pressure in the second hydraulic circuit and therefore the second working chambers of the right and left dampers. The controller actuates the bi-directional pump in a second working mode where the bi-directional pump decreases fluid pressure in the first hydraulic circuit and therefore the first working chambers of the right and left dampers and increases fluid pressure in the second hydraulic circuit and therefore the second working chambers of the right and left dampers.

Advantageously, the single axle suspension systems described herein have a variety of different capabilities not previously available in a single system, including the ability to actively reduce/eliminate pitching behaviors of the vehicle and suspension heave. The reduction of pitching and heave improves the comfort, steering feel, agility, and stability of the vehicle. Because the pressurizing mechanism actively adjusts pitch stiffness of the vehicle by changing the static pressure in the system when greater pitch stiffness is needed, the baseline pitch stiffness can be reduced compared to a vehicle with a conventional anti-roll bar. Therefore, ride comfort and suspension compliance is improved. Comfort is also improved because the active forces are independent of the damping forces. Anti-pitch stiffness can also be applied to reduce body oscillations resulting in improved comfort. The pressurizing mechanism can also be used to reduce the ride height of (i.e., lower) the vehicle or increase the ride height of (i.e., lift/raise) the vehicle. Finally, the single axle suspension systems described herein can provide anti-pitch control and, in some configurations, anti-roll control, and therefore can augment or replace mechanical stabilizer bars/anti-roll bars.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram illustrating an exemplary single axle suspension system that is constructed in accordance with the present disclosure, where the single axle suspension system includes variable flow control valves at each damper and a pressurizing mechanism that is actuated by a ball/screw mechanism;

FIG. 2 is a schematic diagram illustrating another exemplary single axle suspension system that is constructed in accordance with the present disclosure, where the single axle suspension system includes a pressurizing mechanism that is actuated by a ball/screw mechanism, but has no variable flow control valves;

FIG. 3 is a schematic diagram illustrating another exemplary single axle suspension system that is constructed in accordance with the present disclosure, where the single axle suspension system has variable flow control valves at each damper and a pressurizing mechanism that includes a ball/screw mechanism and a variable volume chamber with a floating piston;

FIG. 4 is a schematic diagram illustrating another exemplary single axle suspension system that is constructed in accordance with the present disclosure, where the single axle suspension system has a pressurizing mechanism that includes a ball/screw mechanism and a variable volume chamber with a floating piston, but no variable flow control valves;

FIG. 5 is a schematic diagram illustrating another exemplary single axle suspension system that is constructed in accordance with the present disclosure, where the single axle suspension system has variable flow control valves at each damper and a bi-directional pump as the pressurizing mechanism;

FIG. 6 is a schematic diagram illustrating another exemplary single axle suspension system that is constructed in accordance with the present disclosure, where the single axle suspension system has a bi-directional pump as the pressurizing mechanism, but no variable flow control valves;

FIG. 7 is a schematic diagram illustrating another exemplary single axle suspension system that is constructed in accordance with the present disclosure, where the single axle suspension system has dampers with four working chambers, four variable flow control valves at each damper, a first pressurizing mechanism that includes a first ball/screw mechanism and a first variable volume chamber with a first floating piston, and a second pressurizing mechanism that includes a second ball/screw mechanism and a second variable volume chamber, and a third pressurizing mechanism that includes a bi-directional pump;

FIG. 8 is a schematic diagram illustrating another exemplary single axle suspension system that is constructed in accordance with the present disclosure, where the single axle suspension system has dampers with four working chambers, one variable flow control valve at each damper, a first pressurizing mechanism that includes a first ball/screw mechanism and a first variable volume chamber with a first floating piston, a second pressurizing mechanism that includes a second ball/screw mechanism and a second variable volume chamber, and a third pressurizing mechanism that includes a bi-directional pump;

FIG. 9 is a schematic diagram illustrating another exemplary single axle suspension system that is constructed in accordance with the present disclosure, where the single axle suspension system has dampers with four working chambers, one variable flow control valve at each damper, a first pressurizing mechanism that includes a first ball/screw mechanism and a first variable volume chamber with a first floating piston and a second pressurizing mechanism that includes a dual impeller bi-directional pump;

FIG. 10 is a schematic diagram illustrating the exemplary single axle suspension system shown in FIG. 9, but where the dual impeller bi-directional pump has impellers that rotate in the same rotational direction; and

FIG. 11 is a schematic diagram illustrating another exemplary single axle suspension system that is constructed in accordance with the present disclosure, where the single axle suspension system has dampers with four working chambers, one variable flow control valve at each damper, and a first pressurizing mechanism that includes a first ball/screw mechanism and a first variable volume chamber with a first floating piston.

### DETAILED DESCRIPTION

Referring to the Figures, wherein like numerals indicate corresponding parts throughout the several views, a number of single axle suspension system are disclosed.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

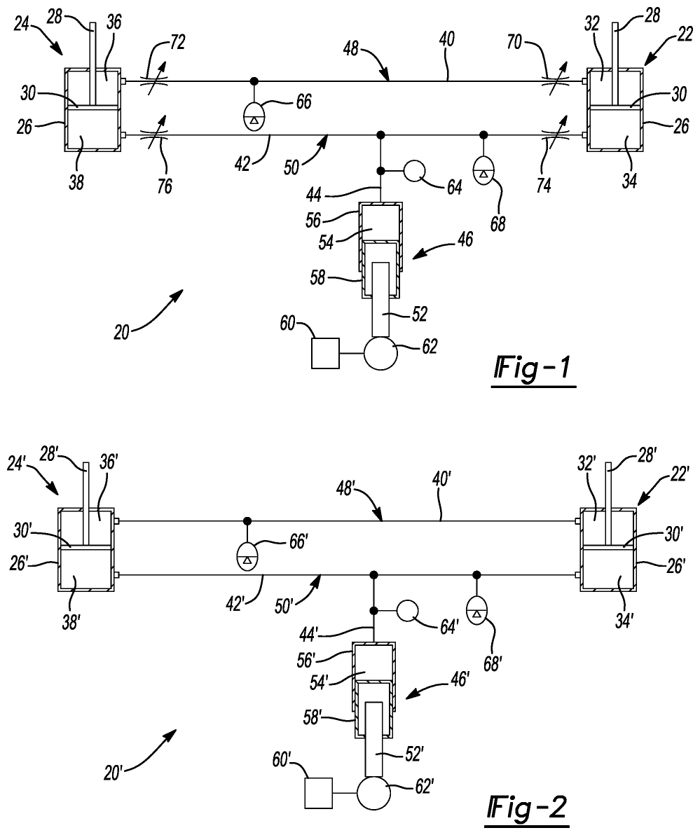

With reference to FIGS. 1-11, several single axle suspension systems are illustrated. It should be appreciated that the single axle suspension systems shown in FIGS. 1-11 may be located at the front end of a vehicle to control suspension movements and provide anti-pitch/heave control for the front wheels of the vehicle, and additionally or alternatively, the single axle suspension systems may be located at the rear end of the vehicle to control suspension movements and provide anti-pitch/heave control for the back wheels of the vehicle.

Each of the single axle suspension systems disclosed herein include a right damper and a left damper. The right and left dampers control (i.e., dampen) up and down (i.e., vertical) movements of the front or rear wheels of the vehicle. Thus, one single axle suspension system may be provided at the front of the vehicle and another single axle suspension system may be provided at the rear of the vehicle. The anti-pitch/heave capabilities of the single axle suspension systems described herein will be explained in greater detail below; however, it should be appreciated that each single axle suspension system can operate independently and on its own and that each single axle suspension systems can be used to either augment or completely replace mechanical stabilizer bars/anti-roll bars. Such mechanical systems require relatively straight, unobstructed runs along each axle between the right and left dampers. Accordingly, the single axle suspension systems disclosed herein offer packaging benefits because the right and left dampers only need to be hydraulically connected to one another.

It should be appreciated that a vehicle may be equipped with two identical single axle suspension systems placed at the front and rear of the vehicle; however, other configurations are possible where the vehicle may include only one of the single axle suspension systems disclosed herein and a convention suspension system at the other axle, or where the single axle suspension system at the front of the vehicle is different from the single axle suspension system at the rear of the vehicle.

With reference to FIG. 1, a single axle suspension system 20 is illustrated with right and left dampers 22, 24. Each of the right and left dampers 22, 24 of the includes a damper housing 26, a piston rod 28, and a piston 30 that is mounted on the piston rod 28. The piston 30 is arranged in sliding engagement with the inside of the damper housing 26 such that the pistons 30 divide the damper housings 26 into first and second working chambers 32, 34, 36, 38. Although other configurations are possible, in the illustrated embodiment the pistons 30 in the right and left dampers 22, 24 are closed pistons with no fluid flow paths defined within or by their structure.

The single axle suspension system 20 also includes a plurality of hydraulic lines 40, 42, 44. The plurality of hydraulic lines 40, 42, 44 includes: a first hydraulic line 40 that extends between and fluidly connects to the first working chamber 32 of the right damper 22 and the first working chamber 36 of the left damper 24, a second hydraulic line 42 that extends between and fluidly connects to the second working chamber 34 of the right damper 22 and the second working chamber 38 of the left damper 24, and a third hydraulic line 44 that extends between and fluidly connects the second hydraulic line 42 to a pressurizing mechanism 46. In the illustrated example, the hydraulic lines 40, 42, 44 are made of flexible tubing (e.g., hydraulic hoses), but other conduit structures and/or fluid passageways can be used alone or in combination with one another.

The first hydraulic line 40 thus forms at least part of a first hydraulic circuit 48 that interconnects the first working chambers 32, 36 of the right and left dampers 22, 24. Meanwhile, the second hydraulic line 42 and the third hydraulic line 44 form at least part of a second hydraulic circuit 50 that interconnects the second working chambers 34, 38 of the right and left dampers 22, 24 and the pressurizing mechanism 46. In other words, the pressurizing mechanism 46 is connected in fluid communication with the second hydraulic circuit 50. It should also be appreciated that there is no cross-over between the first and second hydraulic lines 40, 42 or the first and second hydraulic circuits 48, 50 outside of the right and left dampers 22, 24 and that there are no hydraulic lines or other connections extending between or otherwise connecting the first and second hydraulic lines 40, 42 or the first and second hydraulic circuits 48, 50.

Thus, in accordance with this arrangement, the first working chambers 32, 36 of the right and left dampers 22, 24 are connected in fluid communication with one another and hydraulic fluid can flow between the first working chambers 32, 36 of the right and left dampers 22, 24 via the first hydraulic line 40. The second working chambers 34, 38 of the right and left dampers 22, 24 are connected in fluid communication with one another and hydraulic fluid can flow between the second working chambers 34, 38 of the right and left dampers 22, 24 via the second hydraulic line 42 and between the second hydraulic line 42 and the pressurizing mechanism 46 via the third hydraulic line 44. The first and second hydraulic circuits 48, 50 are isolated from one another and therefore may or may not operate as closed loop systems depending on the arrangement of fluid flowpaths within the right and left dampers 22, 24.

The pressurizing mechanism 46 that is illustrated in FIG. 1 includes a ball/screw mechanism 52 to adjust the volume of a variable volume chamber 54. The pressurizing mechanism 46 is therefore configured to provide active heave control by adding and removing hydraulic fluid to and from the second hydraulic circuit 50, which in turn increases and decreases the static pressure inside the second hydraulic line 42, the third hydraulic line 44, and the second working chambers 34, 38 of the right and left dampers 22, 24 in a manner that is independent of damper movements. In particular, the pressurizing mechanism 46 includes a cylinder 56 and the ball/screw mechanism 52 is configured to actuate a driven piston 58 that is slidably received in the cylinder 56. The driven piston 58 is moveable in a first direction to decrease the volume of the variable volume chamber 54 within the cylinder 56 and push hydraulic fluid out of the variable volume chamber 54 and into the third hydraulic line 44 to increase static pressure in the second hydraulic circuit 50. The driven piston 58 is also moveable in a second direction to increase the volume of the variable volume chamber 54 within the cylinder 56 and draw hydraulic fluid from the third hydraulic line 44 into the variable volume chamber 54 to decrease static pressure in the second hydraulic circuit 50.

A controller 60 is electronically connected to the pressurizing mechanism 46. The controller 60 includes a processor and memory that is programmed to initiate an active heave control operation by actuating the pressurizing mechanism 46. For example, in the illustrated embodiment shown in FIG. 1, the controller 60 is electronically connected to a motor 62 that drives the ball/screw mechanism 52. The processor of the controller 60 initiates the active heave control operation by energizing the motor 62 to drive the driven piston 58 in the first direction or the second direction to increase or decrease the static pressure in the second hydraulic circuit 50. The active heave control operation performed by the controller 60 may be responsive to measurements taken by a pressure sensor 64 that is connected to the second hydraulic circuit 50. For example, in the illustrated embodiment shown in FIG. 1, the pressure sensor 64 is connected in fluid communication with the third hydraulic line 44 and is therefore configured to measure the static pressure in the second hydraulic circuit 50.

As shown in FIG. 1, the first hydraulic circuit 48 includes a first accumulator 66 and the second hydraulic circuit 50 includes a second accumulator 68. In this embodiment, the first and second accumulators 66, 68 are external to the pressurizing mechanism 46. In particular, the first accumulator 66 is connected in fluid communication with the first hydraulic line 40 and the second accumulator 68 is connected in fluid communication with the second hydraulic line 42. The first and second accumulators 66, 68 may be constructed in a number of different ways. For example and without limitation, the first and second accumulators 66, 68 may have accumulation chambers and pressurized gas chambers that are separated by floating pistons or flexible membranes.

The first hydraulic circuit 48 includes a first pair of variable flow control valves 70, 72 that are configured to regulate fluid flow between the first hydraulic circuit 48 and the first working chambers 32, 36 of the right and left dampers 22, 24. Similarly, the second hydraulic circuit 50 includes a second pair of variable flow control valves 74, 76 that are configured to regulate fluid flow between the second hydraulic circuit 50 and the second working chambers 34, 38 of the right and left dampers 22, 24. The first variable flow control valve 70 is positioned between the first working chamber 32 of the right damper 22 and the first hydraulic line 40, while the second variable flow control valve 72 is positioned between the first working chamber 36 of the left damper 24 and the first hydraulic line 40. The third variable flow control valve 74 is positioned between the second working chamber 34 of the right damper 22 and the second hydraulic line 42, while the fourth variable flow control valve 76 is positioned between the second working chamber 38 of the left damper 24 and the second hydraulic line 42. By way of example and without limitation, the variable flow control valves 70, 72, 74, 76 may be electromechanical valves with a combination of passive spring-disk elements and a solenoid. The solenoid of the variable flow control valves 70, 72, 74, 76 may be electrically connected to and actuated by the controller 60 to change the damping characteristics of the right damper 22 and/or left damper 24 (e.g., to soften or firm up the ride).

FIG. 2 illustrates another single axle suspension system 20′ that shares many of the same components as the single axle suspension system 20 illustrated in FIG. 1, but in FIG. 2 the variable flow control valves 70, 72, 74, 76 shown in FIG. 1 have been eliminated. Rather than repeat the description set forth above, the reference numbers in FIG. 2 are the same as those shown in FIG. 1, but in FIG. 2 the reference numbers have been appended with a prime (′) symbol. Thus, the same description for element 20 above applies to element 20′ in FIG. 2 and so on and so forth.

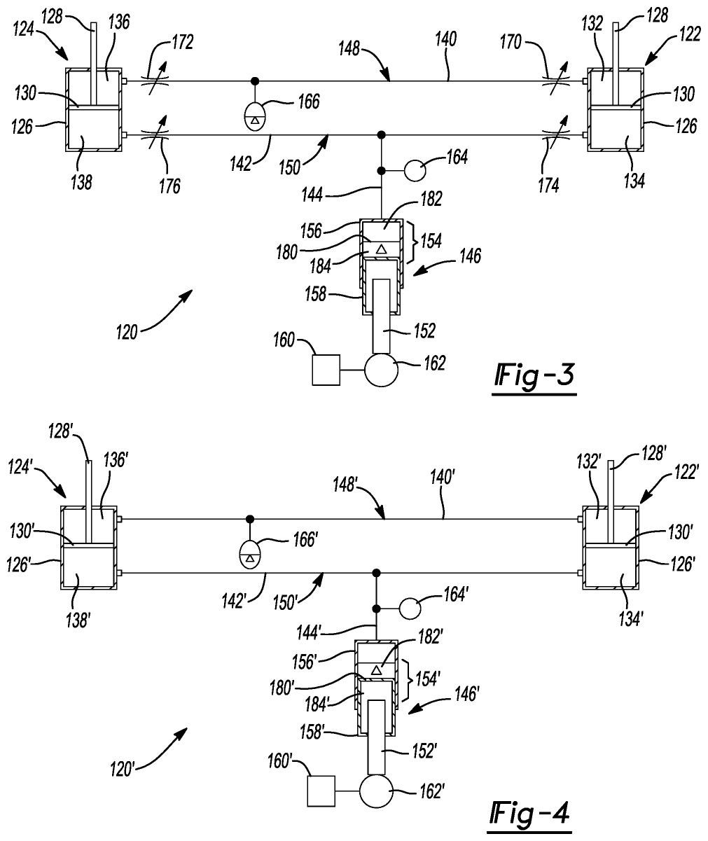

FIG. 3 illustrates another single axle suspension system 120 that shares many of the same components as the single axle suspension system 20 illustrated in FIG. 1, but in FIG. 2 the second accumulator 68 has been eliminated and the single axle suspension system 120 includes a pressurizing mechanism 146 that performs an accumulator function in addition to increasing or decreasing the static pressure in the second hydraulic circuit 150. Rather than repeat the description set forth above, the following paragraphs describe the structure and function of the components in FIG. 3 that are new and/or different from those shown and described in connection with FIG. 1. It should be appreciated that the reference numbers in FIG. 3 are “100” series numbers (e.g., 120, 122, 124, etc.), but otherwise share the same base reference numbers as the corresponding elements in FIG. 1. Thus, the same description for element 20 above applies to element 120 in FIG. 3 and so on and so forth, except as otherwise noted.

As noted above, the pressurizing mechanism 146 of the single axle suspension system 120 illustrated in FIG. 3 performs an additional accumulator function, which eliminates the need for a second accumulator attached to the second hydraulic circuit 150. The pressurizing mechanism 146 in FIG. 3 further includes a floating piston 180 that divides the variable volume chamber 154 into a fluid chamber 182 that is filled with hydraulic fluid and a gas chamber 184 that is filled with a compressible gas. The gas chamber 184 is positioned between the floating piston 180 and the driven piston 158 and the fluid chamber 182 is arranged in fluid communication with the second hydraulic circuit 150 via the third hydraulic line 144. The first hydraulic circuit 148 still includes a standalone accumulator 166, but the second hydraulic circuit 150 does not include a standalone accumulator that is both separate and remote from the pressurizing mechanism 146.

FIG. 4 illustrates another single axle suspension system 120′ that shares many of the same components as the single axle suspension system 120 illustrated in FIG. 3, but in FIG. 4 the variable flow control valves 170, 172, 174, 176 shown in FIG. 3 have been eliminated. Rather than repeat the description set forth above, the reference numbers in FIG. 4 are the same as those shown in FIG. 3, but in FIG. 4 the reference numbers have been appended with a prime (′) symbol. Thus, the same description for element 120 above applies to element 120′ in FIG. 4 and so on and so forth.

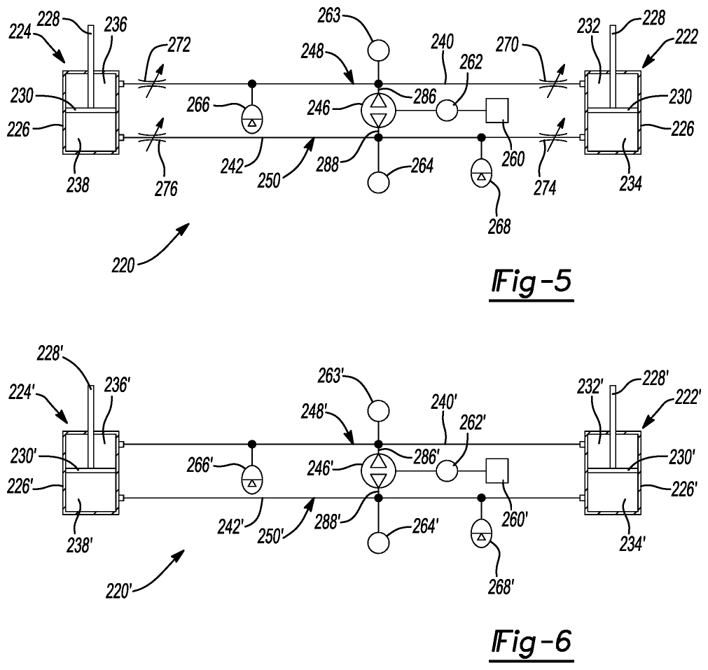

FIG. 5 illustrates another single axle suspension system 220 that shares many of the same components as the single axle suspension system 20 illustrated in FIG. 1, but in FIG. 5 the single axle suspension system 220 includes a pressurizing mechanism 246 in the form of a bi-directional pump that is used to increase and decrease the static pressures in the first and/or second hydraulic circuit 248, 250. Rather than repeat the description set forth above, the following paragraphs describe the structure and function of the components in FIG. 5 that are new and/or different from those shown and described in connection with FIG. 1. It should be appreciated that the reference numbers in FIG. 5 are “200” series numbers (e.g., 220, 222, 224, etc.), but otherwise share the same base reference numbers as the corresponding elements in FIG. 1. Thus, the same description for element 20 above applies to element 220 in FIG. 5 and so on and so forth, except as otherwise noted.

Unlike the pressurizing mechanism 46 in FIG. 1, which is only connected to the second hydraulic circuit 50, the pressurizing mechanism 246 in FIG. 5 is connected in fluid communication with both the first and second hydraulic circuits 248, 250. In this embodiment, the pressurizing mechanism 246 is a bi-directional pump that is configured to provide active heave control by adding and removing hydraulic fluid to and from the first and second hydraulic circuits 248, 250 to increase and decrease pressure inside the first and second hydraulic circuits 248, 250 independent of damper movements. In particular, the bi-directional pump of the pressurizing mechanism 246 is configured to pump hydraulic fluid out of the second hydraulic circuit 250 in a first working mode to decrease static pressure in the second hydraulic circuit 250 and is configured to pump hydraulic fluid into the second hydraulic circuit 250 in a second working mode to increase static pressure in the second hydraulic circuit 250. The bi-directional pump of the pressurizing mechanism 246 has a first bi-directional conduit 286 that is arranged in fluid communication with the first hydraulic circuit 248/first hydraulic line 240 and a second bi-directional conduit 288 that is arranged in fluid communication with the second hydraulic circuit 250/second hydraulic line 242. The first bi-directional conduit 286 acts as a pump outlet and the second bi-directional conduit 288 acts as a pump inlet when the bi-directional pump is operating in the first working mode. By contrast, the first bi-directional conduit 286 acts as the pump inlet and the second bi-directional conduit 288 acts as the pump outlet when the bi-directional pump is operating in the second working mode.

A controller 260 is electronically connected to the pressurizing mechanism 246. By way of example and without limitation, the controller 260 may be electrically connected to a motor 262 that rotationally drives an impeller of the bi-directional pump. The controller 260 includes a processor and memory that is programmed to initiate: (1) the first working mode where the bi-directional pump increases fluid pressure in the first hydraulic circuit 248 and decreases fluid pressure in the second hydraulic circuit 250; and (2) the second working mode where the bi-directional pump decreases fluid pressure in the first hydraulic circuit 248 and increases fluid pressure in the second hydraulic circuit 250. The active heave control operation performed by the controller 260 may be responsive to measurements taken by a first pressure sensor 263 that is connected to the first hydraulic circuit 248 and a second pressure sensor 264 that is connected to the second hydraulic circuit 250. For example, in the illustrated embodiment shown in FIG. 5, the first pressure sensor 263 is connected in fluid communication with the first hydraulic line 240 near the first bi-directional conduit 286 and is therefore configured to measure the static pressure in the first hydraulic circuit 248 and the second pressure sensor 264 is connected in fluid communication with the second hydraulic line 242 near the second bi-directional conduit 288 and is therefore configured to measure the static pressure in the second hydraulic circuit 250.

As shown in FIG. 5, the first hydraulic circuit 248 includes a first accumulator 266 and the second hydraulic circuit 250 includes a second accumulator 268. In this embodiment, the first and second accumulators 266, 268 are external to the pressurizing mechanism 246. In particular, the first accumulator 266 is connected in fluid communication with the first hydraulic line 240 and the second accumulator 268 is connected in fluid communication with the second hydraulic line 242. The first and second accumulators 266, 268 may be constructed in a number of different ways. For example and without limitation, the first and second accumulators 266, 268 may have accumulation chambers and pressurized gas chambers that are separated by floating pistons or flexible membranes.

The first hydraulic circuit 248 includes a first pair of variable flow control valves 270, 272 that are configured to regulate fluid flow between the first hydraulic circuit 248 and the first working chambers 232, 236 of the right and left dampers 222, 224. Similarly, the second hydraulic circuit 250 includes a second pair of variable flow control valves 274, 276 that are configured to regulate fluid flow between the second hydraulic circuit 250 and the second working chambers 234, 238 of the right and left dampers 222, 224. The first variable flow control valve 270 is positioned between the first working chamber 232 of the right damper 222 and the first hydraulic line 240, while the second variable flow control valve 272 is positioned between the first working chamber 236 of the left damper 224 and the first hydraulic line 240. The third variable flow control valve 274 is positioned between the second working chamber 234 of the right damper 222 and the second hydraulic line 242, while the fourth variable flow control valve 276 is positioned between the second working chamber 238 of the left damper 224 and the second hydraulic line 242. By way of example and without limitation, the variable flow control valves 270, 272, 274, 276 may be electromechanical valves with a combination of passive spring-disk elements and a solenoid. The solenoid of the variable flow control valves 270, 272, 274, 276 may be electrically connected to and actuated by the controller 260 to change the damping characteristics of the right damper 222 and/or left damper 224 (e.g., to soften or firm up the ride).

FIG. 6 illustrates another single axle suspension system 220′ that shares many of the same components as the single axle suspension system 220 illustrated in FIG. 5, but in FIG. 6 the variable flow control valves 270, 272, 274, 276 shown in FIG. 5 have been eliminated. Rather than repeat the description set forth above, the reference numbers in FIG. 6 are the same as those shown in FIG. 5, but in FIG. 6 the reference numbers have been appended with a prime (′) symbol. Thus, the same description for element 220 above applies to element 220′ in FIG. 6 and so on and so forth.

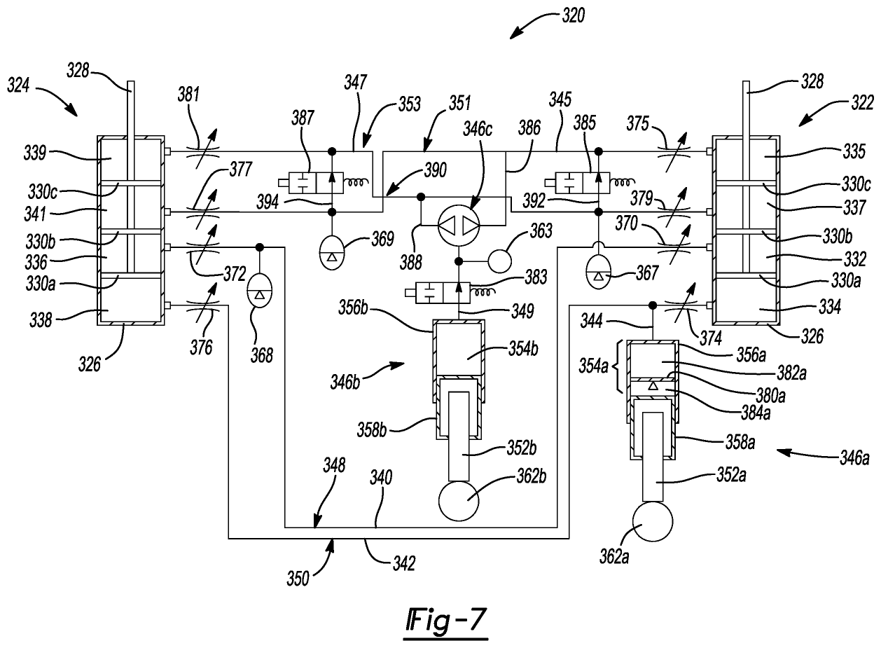

FIG. 7 illustrates another single axle suspension system 320 that shares many of the same components as the single axle suspension systems 20 illustrated in FIGS. 1 and 3, but in FIG. 7 the single axle suspension system 320 includes three pressurizing mechanisms 346a, 346b, 346c that are used to increase and decrease static pressures in four hydraulic circuits 348, 350, 351, 353. Rather than repeat the description set forth above, the following paragraphs describe the structure and function of the components in FIG. 7 that are new and/or different from those shown and described in connection with FIGS. 1 and 3. It should be appreciated that the reference numbers in FIG. 7 are “300” series numbers (e.g., 320, 322, 324, etc.), but otherwise share the same base reference numbers as the corresponding elements in FIGS. 1 and 3. Thus, the same description for elements 20 and 120 above applies to element 320 in FIG. 7 and so on and so forth, except as otherwise noted.

As shown in FIG. 7, each of the right and left dampers 322, 324 of the single axle suspension system 320 includes a damper housing 326, a piston rod 328, and a series of three pistons 330a, 330b, 330c that are mounted on the piston rod 328 at longitudinally spaced positions. The pistons 330a, 330b, 330c are arranged in sliding engagement with the inside of the damper housing 326 such that the pistons 330a, 330b, 330c divide the damper housing 326 of the right damper 322 into a first working chamber 332, a second working chamber 334, a third working chamber 335, and a fourth working chambers 337 and the damper housing 326 of the left damper 324 into a first working chamber 336, a second working chamber 338, a third working chamber 339, and a fourth working chambers 341. Although other configurations are possible, in the illustrated embodiment the pistons 330a, 330b, 330c in the right and left dampers 322, 324 are closed pistons with no fluid flow paths defined within or by their structure.

The single axle suspension system 320 also includes a plurality of hydraulic lines 340, 342, 344, 345, 347, 349. The plurality of hydraulic lines 340, 342, 344, 345, 347, 349 includes: a first hydraulic line 340 that extends between and fluidly connects to the first working chamber 332 of the right damper 322 and the first working chamber 336 of the left damper 324, a second hydraulic line 342 that extends between and fluidly connects to the second working chamber 334 of the right damper 322 and the second working chamber 338 of the left damper 324, a third hydraulic line 344 that extends between and fluidly connects the second hydraulic line 342 to the first pressurizing mechanisms 346a, a fourth hydraulic line 345 that extends between and fluidly connects to the third working chamber 335 of the right damper 322 and the fourth working chamber 341 of the left damper 324, and a fifth hydraulic line 347 that extends between and fluidly connects to the fourth working chamber 337 of the right damper 322 and the third working chamber 339 of the left damper 324, and a sixth hydraulic line 349 that extends between and fluidly connects the second and third pressurizing mechanisms 346b, 346c, which are arranged in fluid communication with the fourth and fifth hydraulic lines 345, 347 via first and second bi-directional pump conduits 386, 388. In the illustrated example, the hydraulic lines 340, 342, 344, 345, 347, 349 are made of flexible tubing (e.g., hydraulic hoses), but other conduit structures and/or fluid passageways can be used alone or in combination with one another.

The first hydraulic line 340 forms at least part of a first hydraulic circuit 348 that interconnects the first working chambers 332, 336 of the right and left dampers 322, 324. The second hydraulic line 342 and the third hydraulic line 344 form at least part of a second hydraulic circuit 350 that interconnects the second working chambers 334, 338 of the right and left dampers 322, 324 and the first pressurizing mechanism 346a. In other words, the first pressurizing mechanism 346a is connected in fluid communication with the second hydraulic circuit 350. The fourth hydraulic line 345 forms at least part of a third hydraulic circuit 351 that interconnects the third working chamber 335 of the right damper 322 to the fourth working chamber 341 of the left damper 324. The fifth hydraulic line 347 forms at least part of a fourth hydraulic circuit 353 that interconnects the fourth working chamber 337 of the right damper 322 to the third working chamber 339 of the left damper 324. Thus, the fourth hydraulic line 345 and therefore the third hydraulic circuit 351 crosses over the fifth hydraulic line 347 and therefore fourth hydraulic circuit 353 at a cross-over point 390, which allows the suspension system 320 to provide roll resistance in a turn. The sixth hydraulic line 349 connects the second pressurizing mechanism 346b in fluid communication with the third pressurizing mechanism 346c and the third pressurizing mechanism 346c is connected in fluid communication with the fourth hydraulic line 345 and therefore the third hydraulic circuit 351 via the first bi-directional pump conduit 386 and is connected in fluid communication with the fifth hydraulic line 347 and therefore fourth hydraulic circuit 353 via the second bi-directional pump conduit 388. The suspension system 320 may also include first and second bridge lines 392, 394 that extend between and interconnect the fourth hydraulic line 345 and therefore the third hydraulic circuit 351 and the fifth hydraulic line 347 and therefore fourth hydraulic circuit 353 on each side of the cross-over point 390. In other words, the first bridge line 392 connects to the fourth and fifth hydraulic lines 345, 347 at positions located between the right damper 322 and the cross-over point 390 (and between the right damper 322 and the first and second bi-directional pump conduits 386, 388), while the second bridge lines 394 connects to the fourth and fifth hydraulic lines 345, 347 at positions located between the left damper 324 and the cross-over point 390 (and between the left damper 324 and the first and second bi-directional pump conduits 386, 388).

It should also be appreciated that there is no cross-over between the first and second hydraulic lines 340, 342 or the first and second hydraulic circuits 348, 350 outside of the right and left dampers 322, 324 and that there are no hydraulic lines or other connections extending between or otherwise connecting the first and second hydraulic lines 340, 342 or the first and second hydraulic circuits 348, 350. Thus, in accordance with this arrangement, the first working chambers 332, 336 of the right and left dampers 322, 324 are connected in fluid communication with one another and hydraulic fluid can flow between the first working chambers 332, 336 of the right and left dampers 322, 324 via the first hydraulic line 340. The second working chambers 334, 338 of the right and left dampers 322, 324 are connected in fluid communication with one another and hydraulic fluid can flow between the second working chambers 334, 338 of the right and left dampers 322, 324 via the second hydraulic line 342 and between the second hydraulic line 342 and the first pressurizing mechanism 346 via the third hydraulic line 344. The first and second hydraulic circuits 348, 350 are isolated from one another and therefore may or may not operate as closed loop systems depending on the arrangement of fluid flowpaths within the right and left dampers 322, 324.

Each of the first and second pressurizing mechanisms 346a, 346b illustrated in FIG. 7 includes a ball/screw mechanism 352a, 352b to adjust the volume of a variable volume chamber 354a, 354b. In particular, each of the first and second pressurizing mechanisms 346a, 346b includes a cylinder 356a, 356b and the ball/screw mechanism 352a, 352b is configured to actuate a driven piston 358a, 358b that is slidably received in the cylinder 356a, 356b. Each driven piston 358a, 358b is moveable in a first direction to decrease the volume of the variable volume chamber 354a, 354b within the cylinder 356a, 356b and push hydraulic fluid out of the variable volume chamber 356a, 356b and into either the third hydraulic line 344 (for the first pressurizing mechanism 346a) or the sixth hydraulic line 349 (for the second pressurizing mechanisms 346b). Each driven piston 358a, 358b is also moveable in a second direction to increase the volume of the variable volume chamber 354a, 354b within the cylinder 356a, 356b and draw hydraulic fluid from either the third hydraulic line 344 or the sixth hydraulic line 349 into the variable volume chamber 354a, 356b.

The first pressurizing mechanism 346a further includes a floating piston 380a that divides the variable volume chamber 354a into a fluid chamber 382a that is filled with hydraulic fluid and a gas chamber 384a that is filled with a compressible gas. The gas chamber 384a is positioned between the floating piston 380a and the driven piston 358a. The fluid chamber 382a of the first pressurizing mechanism 346a is arranged in fluid communication with the third hydraulic line 344. Thus, the first pressurizing mechanism 346a is configured to provide active heave control by adding and removing hydraulic fluid to and from the second hydraulic circuit 350, which in turn increases and decreases the static pressure inside the second hydraulic line 342, the third hydraulic line 344, and the second working chambers 334, 338 of the right and left dampers 322, 324 in a manner that is independent of damper movements.

The second pressurizing mechanism 346b is configured to provide active stiffness control by adding and removing hydraulic fluid to and from the sixth hydraulic line 349, which in turn increases and decreases the static pressure inside the third and fourth hydraulic circuits 351, 353 in a manner that is independent of damper movements.

The third pressurizing mechanism 346c shown in FIG. 7 is a bi-directional pump that is configured to provide active roll control (i.e., roll resistance) by adding and removing hydraulic fluid to and from the third and fourth hydraulic circuits 351, 353 to increase and decrease pressure inside the third and fourth hydraulic circuits 351, 353 independent of damper movements. In particular, the bi-directional pump of the third pressurizing mechanism 346c is configured to pump hydraulic fluid out of the fourth hydraulic circuit 353 and into the third hydraulic circuit 351 in a first working mode to decrease static pressure in the fourth hydraulic circuit 353 and increase static pressure in the third hydraulic circuit 351. Additionally, the bi-directional pump of the third pressurizing mechanism 346c is configured to pump hydraulic fluid out of the third hydraulic circuit 351 and into the fourth hydraulic circuit 353 in a second working mode to decrease static pressure in the third hydraulic circuit 351 and increase static pressure in the fourth hydraulic circuit 353. The bi-directional pump of the third pressurizing mechanism 346c is connected to the first and second bi-directional conduits 386, 388, which are arranged in fluid communication with the third and fourth hydraulic circuits 351, 353. The first bi-directional conduit 386 acts as a pump outlet and the second bi-directional conduit 388 acts as a pump inlet when the bi-directional pump is operating in the first working mode. By contrast, the first bi-directional conduit 386 acts as the pump inlet and the second bi-directional conduit 388 acts as the pump outlet when the bi-directional pump is operating in the second working mode.

While not shown in FIG. 7, the pressurizing mechanisms 346a, 346b, 346c may be electrically connected to a single controller or multiple controllers like the controllers 60, 60′, 160, 160′, 260, 260′ illustrated in FIGS. 1-6. The controller(s) include a processor and memory that is programmed to initiate active heave control operations and/or active roll control operations by actuating one or more of the pressurizing mechanisms 346a, 346b, 346c, either individually or collectively. For example, the controller(s) may initiate an active heave control operation by energizing the motor(s) 362a, 362b of the first and second pressurizing mechanisms 346a, 346b to drive the driven piston(s) 358a, 358b in the first direction or the second direction to increase or decrease the static pressure in the second hydraulic circuit 350 or in both the third and fourth hydraulic circuits 351, 353. The controller(s) may initiate an active heave control operation by energizing the motor(s) 362a, 362b of the first and second pressurizing mechanisms 346a, 346b to drive the driven piston(s) 358a, 358b in the first direction or the second direction to increase or decrease the static pressure in the second hydraulic circuit 350 or in both the third and fourth hydraulic circuits 351, 353. The controller(s) may initiate an active roll control operation by energizing a motor powering the bi-directional pump of the third pressurizing mechanism 346c to initiate: (1) the first working mode where the bi-directional pump of the third pressurizing mechanism 346c increases fluid pressure in the third hydraulic circuit 351 and decreases fluid pressure in the fourth hydraulic circuit 353 to resist rolling to the left (e.g., during a right hand turn); or (2) the second working mode where the bi-directional pump of the third pressurizing mechanism 346c decreases fluid pressure in the third hydraulic circuit 351 and increases fluid pressure in the second hydraulic circuit 353 to resist rolling to the right (e.g., during a left hand turn). The active heave and/or roll control operations performed by the controller(s) may be responsive to measurements taken by a pressure sensor 363 that is connected to the sixth hydraulic line 349.

A first accumulator 367 is connected at the junction between the first bridge line 392 and the fifth hydraulic line 347, a second accumulator 368 is connected in fluid communication with the first hydraulic circuit 348, and a third accumulator 369 is connected at the junction between the second bridge line 394 and interconnect the fourth hydraulic line 345. Thus, it should be appreciated that in this embodiment, the first, second, and third accumulators 367, 368, 369 are external to the pressurizing mechanisms 346a, 346b, 346c and that the first pressurizing mechanism 346a also performs accumulator functions in addition to adjusting the pressures in the second hydraulic circuit 350. The first, second, and third accumulators 367, 368, 369 may be constructed in a number of different ways. For example and without limitation, the first, second, and third accumulators 367, 368, 369 may have accumulation chambers and pressurized gas chambers that are separated by floating pistons or flexible membranes.

The first hydraulic circuit 348 includes a first pair of variable flow control valves 370, 372 that are configured to regulate fluid flow between the first hydraulic circuit 348 and the first working chambers 332, 336 of the right and left dampers 322, 324. Similarly, the second hydraulic circuit 350 includes a second pair of variable flow control valves 374, 376 that are configured to regulate fluid flow between the second hydraulic circuit 350 and the second working chambers 334, 338 of the right and left dampers 322, 324. The third hydraulic circuit 351 includes a third pair of variable flow control valves 375, 377 that are configured to regulate fluid flow between the third hydraulic circuit 351 and the third working chamber 335 of the right damper 322 and between the third hydraulic circuit 351 and the fourth working chamber 341 of the left damper 324, respectively. The fourth hydraulic circuit 353 includes a fourth pair of variable flow control valves 379, 381 that are configured to regulate fluid flow between the fourth hydraulic circuit 353 and the fourth working chamber 337 of the right damper 322 and between the fourth hydraulic circuit 353 and the third working chamber 339 of the left damper 324, respectively. By way of example and without limitation, the variable flow control valves 370, 372, 374, 375, 376, 377, 379, 381 may be electromechanical valves with a combination of passive spring-disk elements and a solenoid. The solenoid of the variable flow control valves 370, 372, 374, 375, 376, 377, 379, 381 may be electrically connected to and actuated by the controller to change the damping characteristics of the right damper 322 and/or left damper 324 (e.g., to soften or firm up the ride).

The single axle suspension system 320 illustrated in FIG. 7 also includes several shut-off valves 383, 385, 387 (i.e., on/off valves). The first shut-off valve 383 is positioned in the sixth hydraulic line 349 between the second and third pressurizing mechanisms 346b, 346c. When the first shut-off valve 383 is open, the second pressurizing mechanism 346b may be actuated to increase or decrease the static pressure in both of the third and fourth hydraulic circuits 351, 353 simultaneously to adjust the stiffness of the right and left dampers 322, 324. When the first shut-off valve 383 is closed, the third pressurizing mechanism 346c may be actuated to either increase pressure in the third hydraulic circuits 351 and decrease pressure in the fourth hydraulic circuit 353 or decrease pressure in the third hydraulic circuits 351 and increase pressure in the fourth hydraulic circuit 353 to achieve active roll control. The second shut-off valve 385 is positioned in the first bridge line 392 between the third and fourth hydraulic circuits 351, 353 and the third shut-off valve 387 is positioned in the second bridge line 394 between the third and fourth hydraulic circuits 351, 353. When the second and third shut-off valves 385, 387 are closed, a pressure differential between the third and fourth hydraulic circuits 351, 353 can be maintained to provide roll resistance. This pressure differential will equalize when the second and third shut-off valves 385, 387 are open, which can be used to provide a comfort setting/operating mode. By way of example and without limitation, the shut-off valves 383, 385, 387 may be electromechanical valves with a solenoid that may be electrically connected to and actuated by the controller to open and close the shut-off valves 383, 385, 387.

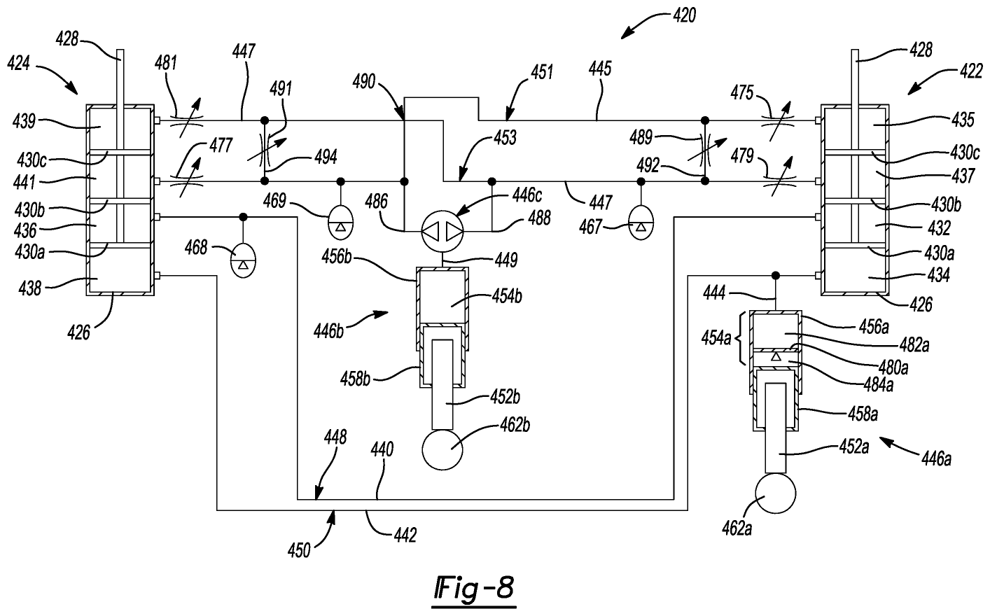

FIG. 8 illustrates another single axle suspension system 420 that shares many of the same components as the single axle suspension system 320 illustrated in FIG. 7, but in FIG. 8 four of the variable flow control valves 370, 372, 374, 376 shown in FIG. 7 and all three of the shut-off valves 383, 385, 387 shown in FIG. 7 have been eliminated. Rather than repeat the description set forth above, the following paragraphs describe the structure and function of the components in FIG. 8 that are new and/or different from those shown and described in connection with FIG. 7. It should be appreciated that the reference numbers in FIG. 8 are “400” series numbers (e.g., 420, 422, 424, etc.), but otherwise share the same base reference numbers as the corresponding elements in FIG. 7. Thus, the same description for elements 320 above applies to element 420 in FIG. 8 and so on and so forth, except as otherwise noted.

The first pair of variable flow control valves 370, 372 and the second pair of variable flow control valves 374, 376 shown in FIG. 7 have been eliminated in FIG. 8. Accordingly, the first and second hydraulic circuits 448, 450 in FIG. 8 are free of any variable flow control valves; however, it should be appreciated that the third hydraulic circuit 451 still includes a third pair of variable flow control valves 475, 477 and the fourth hydraulic circuit 453 still includes a fourth pair of variable flow control valves 479, 481. Also, in this embodiment, the first shut-off valve 383 and the pressure sensor 363 that were positioned between the second and third pressurizing mechanisms 346b, 346c in FIG. 7 have been eliminated such that there is no shut-off valve or pressure sensor in the sixth hydraulic line 449 that extends between the second and third pressurizing mechanisms 446b, 446c in FIG. 8. Additionally, the second and third shut-off valves 385, 387 shown in FIG. 7 have been eliminated in FIG. 8 and have been replaced with variable flow control valves 489, 491, which are positioned in-line with and regulate the fluid flow through the first and second bridge lines 392, 394. The first accumulator 467 is connected to the fifth hydraulic line 447, the second accumulator 468 is connected in fluid communication with the first hydraulic line 440, and the third accumulator 469 is connected in fluid communication with the fourth hydraulic line 445 in this embodiment. Finally, in the embodiment shown in FIG. 8, the first bi-directional conduit 486 that is arranged in fluid communication with the third hydraulic circuit 451 is positioned to the left of the bi-directional pump of the third pressurizing mechanism 446c, while the second bi-directional conduit 488 that is arranged in fluid communication with the fourth hydraulic circuit 453 is positioned to the right of the bi-directional pump of the third pressurizing mechanism 446c, which is the opposite of the arrangement shown in FIG. 7.

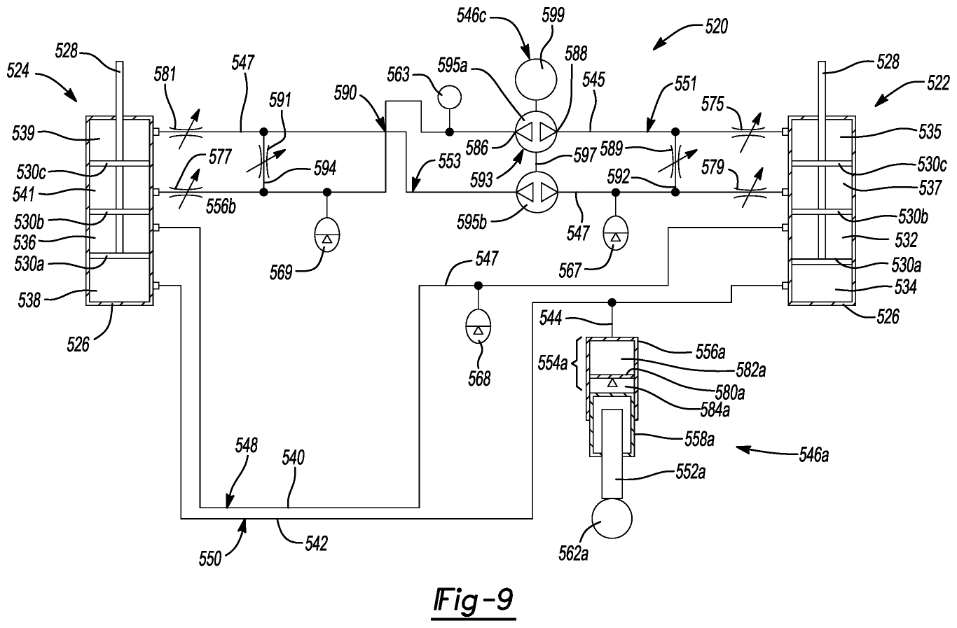

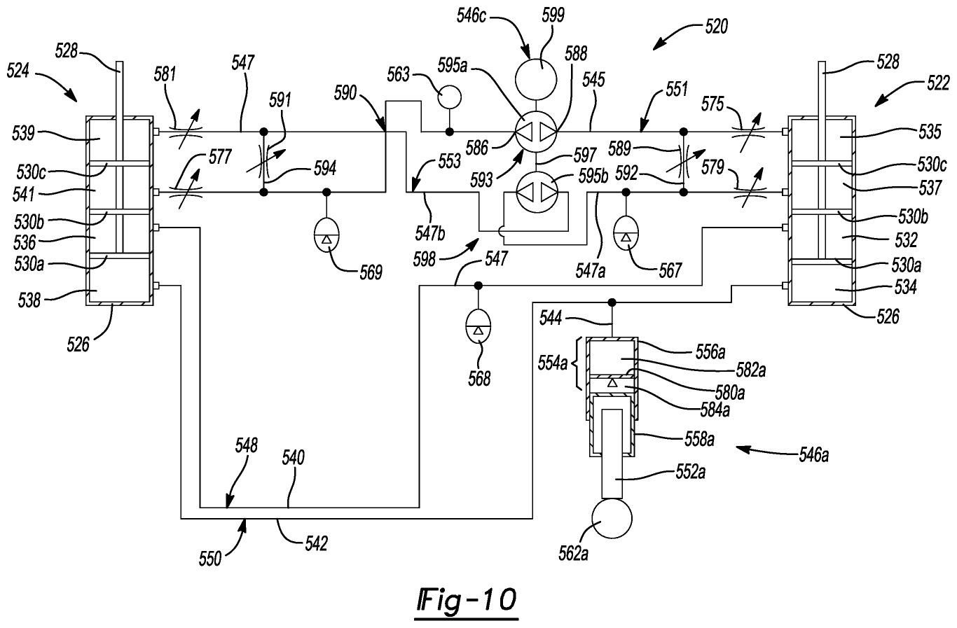

FIGS. 9 and 10 illustrate another single axle suspension system 520 that shares many of the same components as the single axle suspension system 420 illustrated in FIG. 8, but in FIGS. 9 and 10 the second pressurizing mechanism 446b shown in FIG. 8 has been eliminated and the bi-directional pump of the third pressurizing mechanism 446c shown in FIG. 8 has been replaced with a pressurizing mechanism 546c that includes a dual impeller bi-directional pump assembly 593. Rather than repeat the description set forth above, the following paragraphs describe the structure and function of the components in FIGS. 9 and 10 that are new and/or different from those shown and described in connection with FIG. 8. It should be appreciated that the reference numbers in FIGS. 9 and 10 are “500” series numbers (e.g., 520, 522, 524, etc.), but otherwise share the same base reference numbers as the corresponding elements in FIG. 8. Thus, the same description for elements 420 above applies to element 520 in FIGS. 9 and 10 and so on and so forth, except as otherwise noted.

In FIGS. 9 and 10, pressurizing mechanism 546c includes a dual impeller bi-directional pump assembly 593. The dual impeller bi-directional pump assembly 593 includes a first impeller 595a and a second impeller 595b. The first and second impellers 595a, 595b may be supported on or mounted on a common shaft 597, which is rotationally driven by a motor 599 (i.e., an electric motor). The motor 599 may be connected to one or more controllers (not shown in FIGS. 9 and 10) that are programmed to initiate active heave and/or roll control operations. The controller(s) may be responsive to measurements taken by a pressure sensor 563 that is connected to the fourth hydraulic line 545.

The first impeller 595a is arranged in fluid communication with and is configured to pump fluid through the third hydraulic circuit 551 in two opposing directions (e.g., to the right or to the left) depending on the rotational direction that the first impeller 595a is turning in (e.g., clockwise or counterclockwise). The second impeller 595b is arranged in fluid communication with and is configured to pump fluid through the fourth hydraulic circuit 553 in two opposing directions (e.g., to the right or to the left) depending on the rotational direction that the second impeller 595b is turning in (e.g., clockwise or counterclockwise). The dual impeller bi-directional pump assembly 593 is configured such that the first and second impellers 595a, 595b act (i.e., pump) simultaneously in opposite directions. In other words, the dual impeller bi-directional pump assembly 593 is configured such that the first impeller 595a pumps fluid in the fourth hydraulic line 545 in a direction moving away from the right damper 522 and towards the left damper 524 while at the same time the second impeller 595b pumps fluid in the fifth hydraulic line 547 in a direction moving towards from the right damper 522 and away from the left damper 524, and vice versa.

As shown in FIG. 9, this can be achieved by utilizing the motor 599 to drive the first and second impellers 595a, 595b in opposite rotational directions (e.g., where the motor 599 to drives the first impeller 595a in a clockwise direction and the second impeller 595b in a counterclockwise direction or vice versa). Alternatively, as shown in FIG. 10, the first and second impellers 595a, 595b may be fixed to the common shaft 597 and therefore may rotate in the same direction and the fifth hydraulic line 547 may include right and left segments 547a, 547b that cross one another at a second crossing point 598. The right segment 547a of the fifth hydraulic line 547 extends between the right damper 522 and a left side of the dual impeller bi-directional pump assembly 593 while the left segment 547b of the fifth hydraulic line 547 extends between the left damper 524 and a right side of the dual impeller bi-directional pump assembly 593. As a result, fluid flow through the fourth hydraulic circuit is reversed relative to the fluid flow through the third hydraulic circuit even though the first and second impellers 595a, 595b rotate in the same direction (e.g., both the first and second impellers 595a, 595b rotate in a clockwise direction or in a counterclockwise direction, depending on the direction of rotation of the common shaft 597). As another alternative, the fourth hydraulic line 545 could be broken up into two crossing segments as described above instead of the fifth hydraulic line 547 to achieve the same effect.

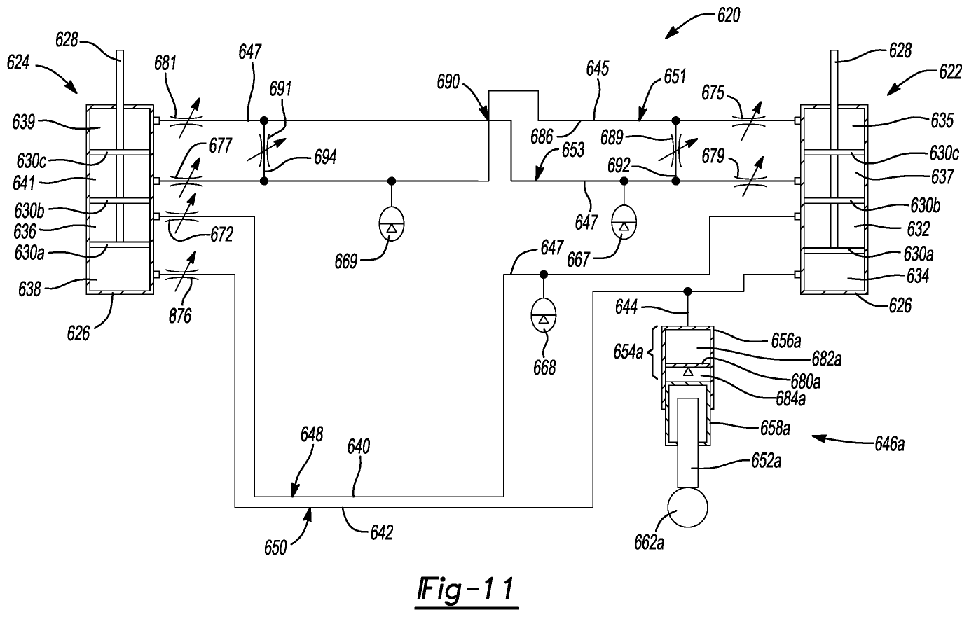

FIG. 11 illustrates another single axle suspension system 620 that shares many of the same components as the single axle suspension system 520 illustrated in FIGS. 9 and 10, but in FIG. 11 pressurizing mechanism 546c and the dual impeller bi-directional pump assembly 593 shown in FIGS. 9 and 10 have been eliminated. Rather than repeat the description set forth above, the following paragraphs describe the structure and function of the components in FIG. 11 that are new and/or different from those shown and described in connection with FIGS. 9 and 10. It should be appreciated that the reference numbers in FIG. 11 are “600” series numbers (e.g., 620, 622, 624, etc.), but otherwise share the same base reference numbers as the corresponding elements in FIGS. 9 and 10. Thus, the same description for elements 520 above applies to element 620 in FIG. 11 and so on and so forth, except as otherwise noted.

With the elimination of pressurizing mechanism 546c and the dual impeller bi-directional pump assembly 593 shown in FIGS. 9 and 10, the single axle suspension system 620 in FIG. 11 adds back in the third and fourth variable flow control valves 372, 376 shown in FIG. 7. In particular, the first hydraulic circuit 648 in FIG. 11 includes a third variable flow control valve 672 in the first hydraulic line 640 that controls fluid flow between the first hydraulic circuit 648 and the first working chamber 636 of the left damper 324. Meanwhile, the second hydraulic circuit 650 in FIG. 11 includes a fourth variable flow control valve 676 in the second hydraulic line 642 that controls fluid flow between the second hydraulic circuit 650 and the second working chamber 638 of the left damper 324.

Many other modifications and variations of the present disclosure are possible in light of the above teachings and may be practiced otherwise than as specifically described while within the scope of the appended claims.

1. A single axle suspension system, comprising:
right and left dampers each including a damper housing, a piston rod, and one or more pistons mounted on the piston rod and arranged in sliding engagement inside the damper housing such that the one or more pistons divide the damper housing into at least a first working chamber and a second working chamber;
a first hydraulic circuit connecting the first working chamber of the right damper and the first working chamber of the left damper;
a second hydraulic circuit connecting the second working chamber of the right damper and the second working chamber of the left damper; and
a first pressurizing mechanism connected in fluid communication with the second hydraulic circuit,
wherein the first pressurizing mechanism is configured to provide active heave control by adding and removing hydraulic fluid to and from the second hydraulic circuit to increase and decrease pressure inside the second hydraulic circuit independent of damper movements.

2. The single axle suspension system set forth in claim 1, wherein there is no cross-over between the first and second hydraulic circuits outside of the right and left dampers.

3. The single axle suspension system set forth in claim 2, wherein the first pressurizing mechanism includes a variable volume chamber with a driven piston that is moveable in a first direction to decrease volume in the variable volume chamber and push hydraulic fluid out into the second hydraulic circuit to increase static pressure in the second hydraulic circuit and that is moveable in a second direction to increase volume in the variable volume chamber and draw hydraulic fluid from the second hydraulic circuit into the variable volume chamber to decrease static pressure in the second hydraulic circuit.

4. The single axle suspension system set forth in claim 3, wherein the first pressurizing mechanism further includes a floating piston that divides the variable volume chamber into a fluid chamber that is filled with hydraulic fluid and is arranged in fluid communication with the second hydraulic circuit and a gas chamber between the floating piston and the driven piston that is filled with a compressible gas such that the first pressurizing mechanism includes an accumulator function.

5. The single axle suspension system set forth in claim 3, wherein the first pressurizing mechanism includes a ball/screw mechanism that is configured to operably drive movement of the driven piston in the first and second directions.

6. The single axle suspension system set forth in claim 1, wherein the first pressurizing mechanism is a bi-directional pump that is configured to pump hydraulic fluid out of the second hydraulic circuit in a first working mode to decrease static pressure in the second hydraulic circuit and is configured to pump hydraulic fluid into the second hydraulic circuit in a second working mode to increase static pressure in the second hydraulic circuit.

7. The single axle suspension system as set forth in claim 6, wherein the bi-directional pump has a first bi-directional conduit that is arranged in fluid communication with the first hydraulic circuit and a second bi-directional conduit that is arranged in fluid communication with the second hydraulic circuit.

8. The single axle suspension system as set forth in claim 7, wherein the first bi-directional conduit acts as a pump outlet and the second bi-directional conduit acts as a pump inlet when the bi-directional pump is operating in the first working mode and wherein the first bi-directional conduit acts as the pump inlet and the second bi-directional conduit acts as the pump outlet when the bi-directional pump is operating in the second working mode.

9. The single axle suspension system set forth in claim 1, wherein the right and left dampers each include a first piston, a second piston, and a third piston that are mounted on the piston rod at longitudinally spaced positions to divide the damper housing of each damper into the first and second working chambers as well as a third working chamber and a fourth working chamber.

10. The single axle suspension system set forth in claim 9, further comprising:
a third hydraulic circuit connecting the third working chamber of the right damper to the fourth working chamber of the left damper;
a fourth hydraulic circuit connecting the fourth working chamber of the right damper to the third working chamber of the left damper;
a second pressurizing mechanism connected in fluid communication with at least the third hydraulic circuit,
wherein the first and second pressurizing mechanisms each includes a variable volume chamber with a driven piston that is moveable in a first direction to decrease volume in the variable volume chamber and push hydraulic fluid out of the variable volume chamber and a second direction to increase volume in the variable volume chamber and draw hydraulic fluid into the variable volume chamber.

11. The single axle suspension system set forth in claim 10, further comprising:
a third pressurizing mechanism including a bi-directional pump that is connected in fluid communication with both the third and fourth hydraulic circuits and is configured to provide active roll control by adding and removing hydraulic fluid to and from the third and fourth hydraulic circuits to increase and decrease pressure inside the third and fourth hydraulic circuits independent of damper movements.

12. The single axle suspension system set forth in claim 1, wherein the first hydraulic circuit includes a first pair of variable flow control valves that are configured to regulate fluid flow between the first hydraulic circuit and the first working chambers of the right and left dampers and wherein the second hydraulic circuit includes a second pair of variable flow control valves that are configured to regulate fluid flow between the second hydraulic circuit and the second working chambers of the right and left dampers.

13. The single axle suspension system set forth in claim 1, further comprising:
a controller that is electronically connected to the pressurizing mechanism, the controller including a processor and memory that is programmed to initiate an active heave control operation by actuating the pressurizing mechanism.

14. A single axle suspension system, comprising:
right and left dampers each including a damper housing, a piston rod, and a piston that is mounted on the piston rod and arranged in sliding engagement inside the damper housing such that the piston divides the damper housing into first and second working chambers;
a first hydraulic line extending between and connecting the first working chamber of the right damper and the first working chamber of the left damper;
a second hydraulic line extending between and connecting the second working chamber of the right damper and the second working chamber of the left damper; and
a pressurizing mechanism connected in fluid communication with the second hydraulic line,
wherein the pressurizing mechanism includes a ball/screw mechanism to adjust the volume of a variable volume chamber and is configured to provide active heave control by adding and removing hydraulic fluid to and from the second hydraulic lines to increase and decrease pressure inside the second hydraulic line independent of damper movements.

15. The single axle suspension system set forth in claim 14, wherein the ball/screw mechanism is configured to actuate a driven piston that is moveable in a first direction to decrease the volume of the variable volume chamber and push hydraulic fluid out into the second hydraulic line to increase static pressure in the second hydraulic line and that is moveable in a second direction to increase the volume of the variable volume chamber and draw hydraulic fluid from the second hydraulic line into the variable volume chamber to decrease static pressure in the second hydraulic line.

16. The single axle suspension system set forth in claim 15, further comprising:
a controller that is electronically connected to a motor that drives the ball/screw mechanism, the controller including a processor and memory that is programmed to initiate an active heave control operation by energizing the motor to drive the driven piston in the first direction or the second direction to increase or decrease the static pressure in the second hydraulic line.

17. The single axle suspension system set forth in claim 14, wherein there is no cross-over between the first and second hydraulic line.

18. A single axle suspension system, comprising:
right and left dampers each including a damper housing, a piston rod, and a piston that is mounted on the piston rod and arranged in sliding engagement inside the damper housing such that the piston divides the damper housing into first and second working chambers;
a first hydraulic circuit connecting the first working chamber of the right damper and the first working chamber of the left damper;
a second hydraulic circuit connecting the second working chamber of the right damper and the second working chamber of the left damper; and
a pressurizing mechanism connected in fluid communication with the first and second hydraulic circuits,
wherein the pressurizing mechanism is a bi-directional pump that is configured to provide active heave control by adding and removing hydraulic fluid to and from the first and second hydraulic circuits to increase and decrease pressure inside the first and second hydraulic circuits independent of damper movements.

19. The single axle suspension system set forth in claim 18, further comprising:
a controller that is electronically connected to the pressurizing mechanism, the controller including a processor and memory that is programmed to initiate:
a first working mode where the bi-directional pump increases fluid pressure in the first hydraulic circuit and decreases fluid pressure in the second hydraulic circuit; and
a second working mode where the bi-directional pump decreases fluid pressure in the first hydraulic circuit and increases fluid pressure in the second hydraulic circuit.

20. The single axle suspension system as set forth in claim 18, wherein the bi-directional pump has a first bi-directional conduit that is arranged in fluid communication with the first hydraulic line and a second bi-directional conduit that is arranged in fluid communication with the second hydraulic line, wherein the first bi-directional conduit acts as a pump outlet and the second bi-directional conduit acts as a pump inlet when the bi-directional pump is operating in the first working mode, and wherein the first bi-directional conduit acts as the pump inlet and the second bi-directional conduit acts as the pump outlet when the bi-directional pump is operating in the second working mode.
